(19) United States
(12) Patent Application Publication
(10) Pub. No.: US 2018/0231909 A1
(43) Pub. Date: Aug. 16, 2018

(54) IMAGE CORRECTION DEVICE

(71) Applicants: KABUSHIKI KAISHA TOSHIBA, Tokyo (JP); TOSHIBA TEC KABUSHIKI KAISHA, Tokyo (JP)

(72) Inventor: Kazumasa Takada, Numazu Shizuoka (JP)

(21) Appl. No.: 15/467,070

(22) Filed: Mar. 23, 2017

(30) Foreign Application Priority Data
Feb. 10, 2017 (JP) 2017-022831

(51) Int. Cl. B41J 2/385

(52) U.S. Cl. CPC G03G 15/043; H04N 1/00018

(57) ABSTRACT

According to one embodiment, there is provided an image correction device including a PWM control unit configured to acquire predefined correction information corresponding to an image forming target line among a plurality of lines forming image data from an SRAM, adjust a timing for forming an image for the image forming target line on the basis of the acquired correction information, and form an image for the image forming target line according to the adjusted timing.

### CROSS-REFERENCE TO RELATED APPLICATION

This application is based upon and claims the benefit of priority from Japanese Patent Application No. 2017-022831, filed Feb. 10, 2017, the entire contents of which are incorporated herein by reference.

### FIELD

Embodiments described herein relate generally to an image correction device.

### BACKGROUND

An electrophotographic image forming apparatus includes many mechanism components such as a laser exposure device, a photoconductive drum, a transfer belt, and a fixing device. If there is a variation in dimension accuracy of such mechanism components, an image formed on a recording medium such as a printing paper sheet is distorted, and thus image quality deteriorates.

JP-A-2005-254748 discloses a technique of correcting (inversely correcting) distortion of an image by performing interpolation on image data. However, if pixels are added or deleted due to the interpolation, there is a problem in that color deviation or step difference, or a stepped image is generated, and thus image quality deteriorates.

### DESCRIPTION OF THE DRAWINGS

FIG. 1 is a diagram illustrating a configuration of a printer including an image correction device according to an embodiment.

FIG. 2 is a perspective view illustrating a configuration of a laser exposure device illustrated in FIG. 1.

FIG. 3 is a diagram for explaining an example of correcting image distortion.

FIG. 4 is a diagram for explaining another example of correcting image distortion.

FIG. 5 is a block diagram schematically illustrating a configuration of the image correction device.

FIG. 6 is a block diagram illustrating examples of the image correction device and peripheral circuits thereof.

FIG. 7 is a block diagram illustrating a part of the image correction device.

FIG. 8 is a diagram illustrating a configuration of a laser exposure device according to another embodiment.

### DETAILED DESCRIPTION

An object of exemplary embodiments is to provide an image correction device capable of preventing deterioration in image quality and correcting image distortion.

In general, according to one embodiment, there is provided an image correction device including an acquisition unit configured to acquire predefined correction information corresponding to an image forming target line among a plurality of lines forming image data; and a control unit configured to adjust a timing for forming an image for the image forming target line on the basis of the correction information acquired by the acquisition unit, and form an image for the image forming target line according to the adjusted timing.

### First Embodiment

Hereinafter, exemplary embodiments will be described with reference to the drawings. An image correction device of the present embodiment corrects image distortion before an image is formed by an image forming apparatus such as a laser color printer. In the following description, a case where the image correction device is provided in a color laser printer (hereinafter, referred to as a printer) will be described. The same reference numerals are given to the same constituent elements throughout the drawings.

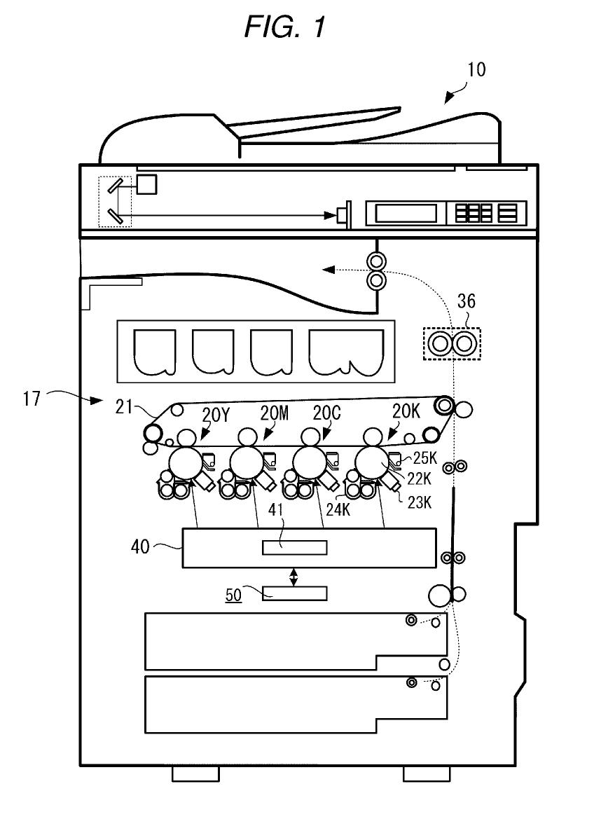

As illustrated in FIG. 1, a printer 10 includes a printing unit 17, a laser exposure device 40, and an image correction device 50.

The printing unit 17 exposes a photoconductive drum to a laser beam from the laser exposure device 40 so as to form (print) an image on a recording medium. The printing unit 17 includes image forming portions 20Y, 20M, 20C and 20K of respective colors such as yellow (Y), magenta (M), cyan (C), and black (K). The image forming portions 20Y, 20M, 20C and 20K are disposed in parallel from an upstream side to a downstream side under an intermediate transfer belt 21.

The image forming portion 20K includes a photoconductive drum 22K, a charger 23K, a developing device 24K, a cleaner 25K, and the like. A surface of the photoconductive drum 22K is irradiated with a laser beam corresponding to black (K) by the laser exposure device 40, and thus an electrostatic latent image is formed thereon. The charger 23K uniformly entirely charges the surface of the photoconductive drum 22K. The developing device 24K supplies a two-component developer formed of toner and carriers to the photoconductive drum 22K, and forms a toner image on the surface of the photoconductive drum 22K.

The toner image formed on the photoconductive drum 22K is primarily transferred onto the intermediate transfer belt 21. The cleaner 25K removes toner remaining on the surface of the photoconductive drum 22K after the primary transfer. The image forming portions 20Y, 20M and 20C have the same configuration as the configuration of the image forming portion 20K.

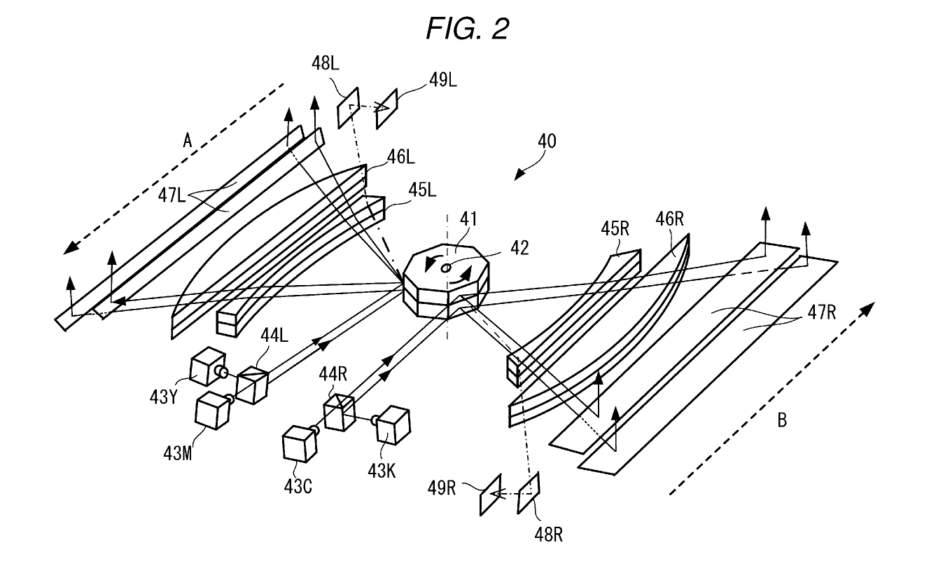

As illustrated in FIG. 2, the laser exposure device 40 includes a polygon mirror 41, laser light sources 43Y, 43M, 43C and 43K, beam splitters 44L and 44R, first fθ lenses 45L and 45R, second fθ lenses 46L and 46R, reflection mirrors 47L and 47R, cylinder mirrors 48L and 48R, and optical sensors 49L and 49R.

The laser light sources 43Y, 43M, 43C and 43K respectively emit laser beams obtained by modulating output light into image data for yellow (Y), magenta (M), cyan (C), and black (K).

The laser light sources 43Y and 43M emit laser beams toward the beam splitter 44L. The beam splitter 44L deflects the laser beams which are incident from the laser light sources 43Y and 43M to the polygon mirror 41. In other words, laser beams from the laser light sources 43Y and 43M are applied to the polygon mirror 41 via the beam splitter 44L. The laser light sources 43C and 43K emit laser beams toward the beam splitter 44R. The beam splitter 44R deflects the laser beams which are incident from the laser light sources 43K and 43C toward the polygon mirror 41. In other words, laser beams from the laser light sources 43C and 43K are applied to the polygon mirror 41 via the beam splitter 44R.

The polygon mirror 41 is formed of two stages such as upper and lower stages, and is rotated in a predetermined direction (here, a counterclockwise) centering on a rotation shaft 42. Each laser beam is reflected in substantially symmetrical directions by the polygon mirror 41. Scanning with the respective laser beams occurs in directions indicated by dotted lines A and B in FIG. 2 due to the rotation of the polygon mirror 41.

The reflection mirrors 47L folds laser beams transmitted through the first fθ lens 45L and the second fθ lens 46L. The photoconductive drums of the image forming portions 20Y and 20M are respectively exposed to the laser beams (Y and M) folded by the reflection mirror 47L. On the other hand, the reflection mirrors 47R folds laser beams transmitted through the first fθ lens 45R and the second fθ lens 46R. The photoconductive drums of the image forming portions 20C and 20K are respectively exposed to the laser beams (C and K) folded by the reflection mirror 47R.

The cylinder mirror 48L and the optical sensor 49L are provided in an over-scan region (a region which does not contribute to exposure) around a scanning start end of the reflection mirror 47L. On the other hand, the cylinder mirror 48R and the optical sensor 49R are provided in an over-scan region around a scanning start end of the reflection mirror 47R. The optical sensors 49L and 49R form a beam detector. The optical sensors 49L and 49R detect laser beams whenever scanning corresponding to image data of one line is performed, and supplies a detection signal BD to the image correction device 50.

The image correction device 50 performs adjustment of an image writing position in a main scanning direction, and fine adjustment and modulation of an image reading clock on the basis of a set value which is set in advance, corresponding to an image forming target line at timings at which laser beams are detected by the optical sensors 49L and 49R.

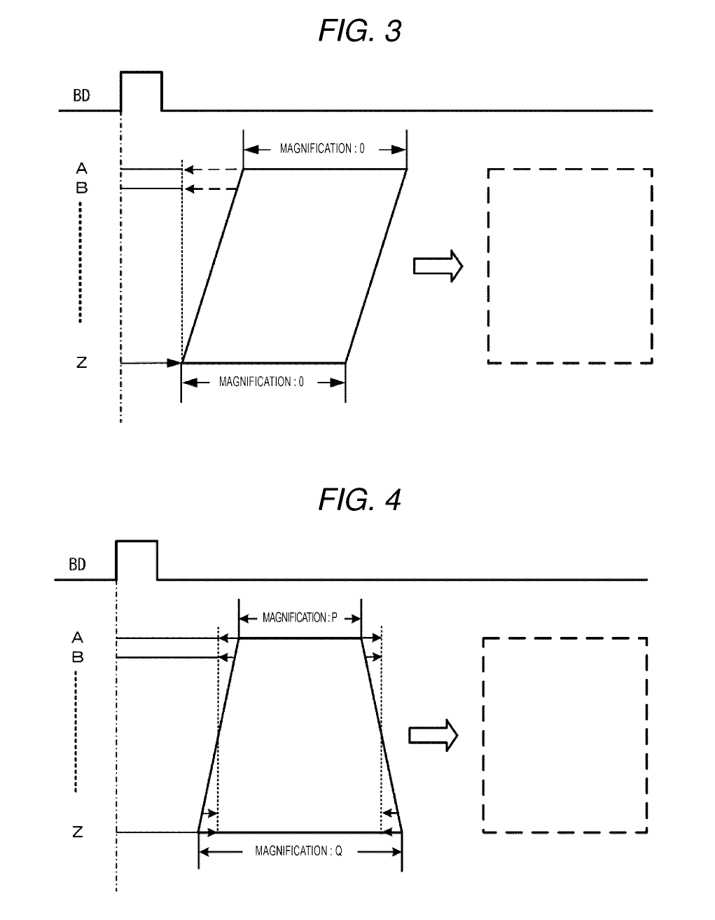

A description will be made of an aspect of distortion correction performed by the image correction device 50. For example, as illustrated in FIG. 3, if an image distorted into a parallelogram shape is corrected to a rectangular shape, the image correction device 50 corrects the distortion by adjusting an image writing position (writing timing) in the main scanning direction.

Specifically, a position of a first line A in an image is delayed, and delay is gradually reduced toward a final line Z. Therefore, a writing position of the first line A is corrected to be earlier and thus to come close to a reference signal BD, and, subsequently, writing positions of remaining lines including a line B toward the line Z are corrected to gradually come close to a writing position of the final line Z. A rectangular image can be formed as indicated by a dotted line through this correction.

A writing position of the final line Z may be corrected to be later and thus to become distant from the reference signal BD, and writing positions of remaining lines including the line Z toward the line B may be corrected to become close to the writing position of the first line A. Alternatively, set values for writing positions of the respective lines may be set to match a writing position of an intermediate line between the first line A and the final line Z.

If trapezoidal distortion is similar to a straight line, linear interpolation may be performed on the basis of information regarding a writing position of the first line A and a writing position of the final line Z so as to calculate writing positions of the line B to the line (Z−1), and a calculation result may be stored for each line.

For example, as illustrated in FIG. 4, if an image distorted into a trapezoidal shape is corrected to a rectangular shape, the image correction device 50 corrects an image writing position in the main scanning direction and magnification of an image.

Specifically, an image in the first line A is reduced, a reduction amount gradually decreases from the second line B toward the final line Z, and the final line Z conversely enlarges. Thus, the image illustrated in FIG. 4 shows an image distorted into a trapezoidal shape as a whole. In this case, a writing position of the first line A is made to come close to the reference signal BD, and the magnification of the image is increased through correction. Also with respect to the following line B to final line Z, writing positions and the magnifications of the image are corrected to be gradually different from each other and thus to come close to a writing position and a magnification of an intermediate line between the first line A and the final line Z. Set values of a writing position and a magnification are generated and stored for each line. A rectangular image can be formed as indicated by a dotted line through this correction.

Correction of the magnification of an image is performed by finely adjusting a frequency of image reading clocks. Specifically, an image is reduced by reducing a cycle of a reference image reading clock, and an image is enlarged by increasing the cycle of the reference reading clock. For example, if the cycle of the reference reading clock is 100 nsec, the cycle is set to 101 nsec, and thus an image is enlarged.

A single line may be divided into a plurality of regions in the main scanning direction, and an image reading clock may be finely adjusted for each region. Hereinafter, this fine adjustment will be referred to as modulation. By using this modulation process, any correction can be performed so that a single line is divided into a plurality of regions, and thus an image is compressed and/or decompressed. If an image reading clock is finely adjusted or modulated, for example, an image of 600 dpi can be corrected to the pixel unit or less (for example, 1/8 pixels).

For example, a central processing unit (CPU) of the printer 10 determines a distortion form (distortion shape) of an image formed by the printer 10 or the extent of distortion on the basis of a lattice pattern image (sample) and an output result of the pattern image, and sets and stores a set value for correcting the distortion for each line depending on a determination result. A service person may determine a distortion form or the extent of distortion of an image on the basis of the image formed by the printer 10, and may set and store a set value for correcting the distortion for each line in the printer 10 depending on a determination result.

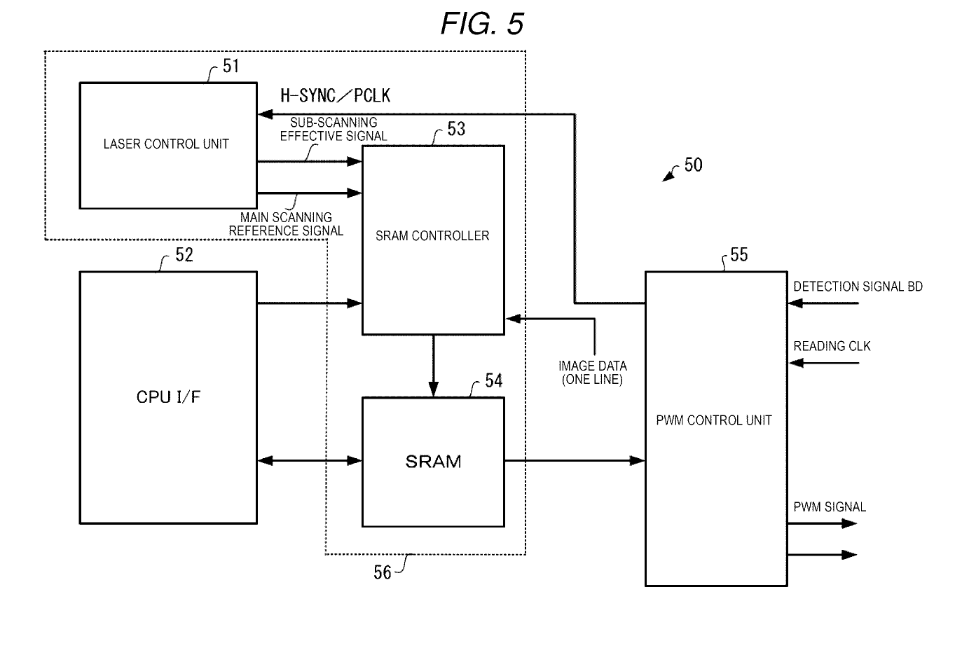

With reference to FIG. 5, a description will be made of a configuration of the image correction device 50. The image correction device 50 includes a laser control unit 51, a CPU interface 52, a static random access memory (SRAM) controller 53, an SRAM 54, and a pulse width modulation (PWM) control unit 55.

The detection signal BD is supplied to the PWM control unit 55 from the optical sensors 49L and 49R whenever scanning corresponding to image data of one line is performed. A writing position adjustment value for adjusting an image writing position (writing timing) in the main scanning direction is supplied to the PWM control unit 55 from the SRAM 54, and thus the PWM control unit 55 adjusts the detection signal BD on the basis of the set value. The PWM control unit 55 supplies a scanning synchronization signal H-SYNC (a synchronization signal in which a writing position is adjusted) obtained through the adjustment to the laser control unit 51.

A reference clock CLK for reading an image is supplied to the PWM control unit 55. A magnification adjustment value for adjusting the magnification of an image in the main scanning direction is supplied to the PWM control unit 55 from the SRAM 54, and the PWM control unit 55 adjusts the reference clock CLK by using the set value. The PWM control unit 55 supplies a clock PCLK (a clock in which the magnification is adjusted) obtained through the adjustment to the laser control unit 51.

The laser control unit 51 includes a main scanning counter and a sub-scanning counter. The main scanning counter generates a main scanning reference signal by counting the clock PCLK. The sub-scanning counter generates a sub-scanning effective signal by counting the scanning synchronization signal H-SYNC. A start position and an end position (both ends in the main scanning direction) of each line image of an image in one page are identified by using the main scanning reference signal. A start line and an end line (both ends in the sub-scanning direction) of the image in one page are identified by using the sub-scanning effective signal. Therefore, an effective image region in which an image is present in one page can be determined by using the main scanning reference signal and the sub-scanning effective signal.

The laser control unit 51 performs other image processes, for example, calibration. Generally, in an image forming apparatus, if images are printed on a plurality of kinds of paper sheets by using the same image data, the images may be reproduced in different grayscales for the respective paper sheets. Therefore, calibration is performed in order to correct grayscale reproduction differences.

The CPU interface 52 stores set values corresponding to one page for adjusting an image writing position or the magnification of an image in the main scanning direction in the SRAM 54 for each line. The CPU interface 52 controls the SRAM controller 53 to read the set values corresponding to one page stored in the SRAM 54 in the unit of one line.

The SRAM controller 53 supplies a read control signal to the SRAM 54 on the basis of the main scanning reference signal and the sub-scanning effective signal from the laser control unit 51, and reads the set values stored in the SRAM 54 in the unit of one line. The set values read from the SRAM 54 are supplied to the PWM control unit 55.

The SRAM controller 53 determines a period in which other image processes such as calibration are performed on the basis of the main scanning reference signal and the sub-scanning effective signal, and performs control for changing the set values in periods other than the calibration period.

Image data (multi-value image data) of one line is supplied to the SRAM controller 53, and is temporarily stored in the SRAM 54. The SRAM controller 53 reads the image data of one line stored in the SRAM 54 on the basis of the main scanning reference signal and the sub-scanning effective signal, and supplies the image data to the PWM control unit 55.

The PWM control unit 55 performs pulse width modulation on the image data received from the SRAM controller 53 so as to generate a binary signal (1 bit PWM signal). The 1 bit PWM signal is obtained by performing adjustment of an image writing position in the main scanning direction, or fine adjustment or modulation (magnification correction). The PWM control unit 55 supplies the generated PWM signal to a laser driver (a laser driver 64 which will be described later) so as to drive the laser light sources 43Y, 43M, 43C and 43K. Consequently, distortion is substantially corrected before an image is formed, and the photoconductive drums 22Y, 22M, 22C and 22K are exposed to laser beams emitted from the respective laser light sources 43Y, 43M, 43C and 43K by using a signal based on the corrected image.

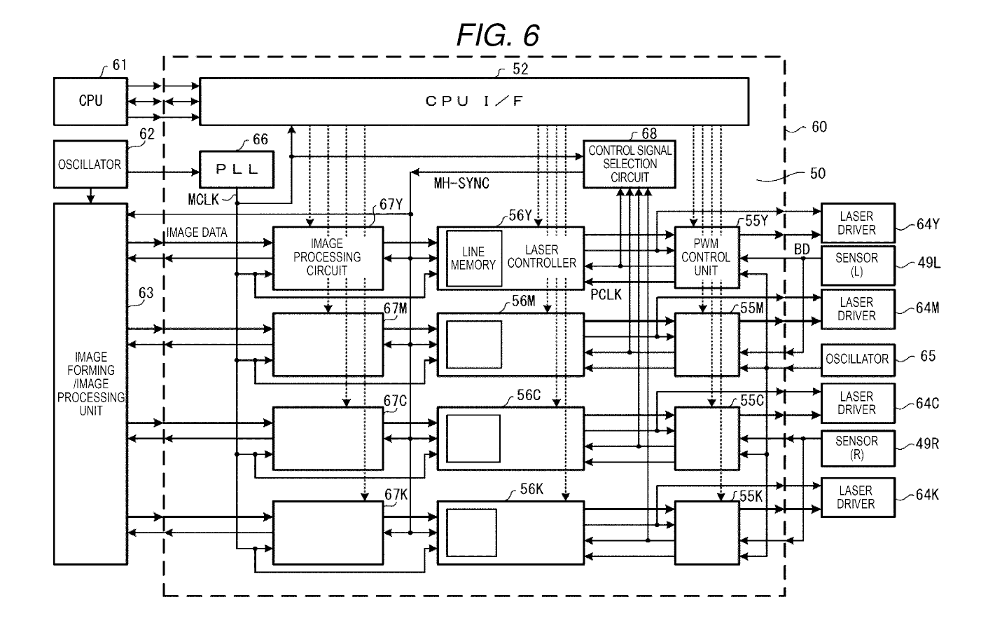

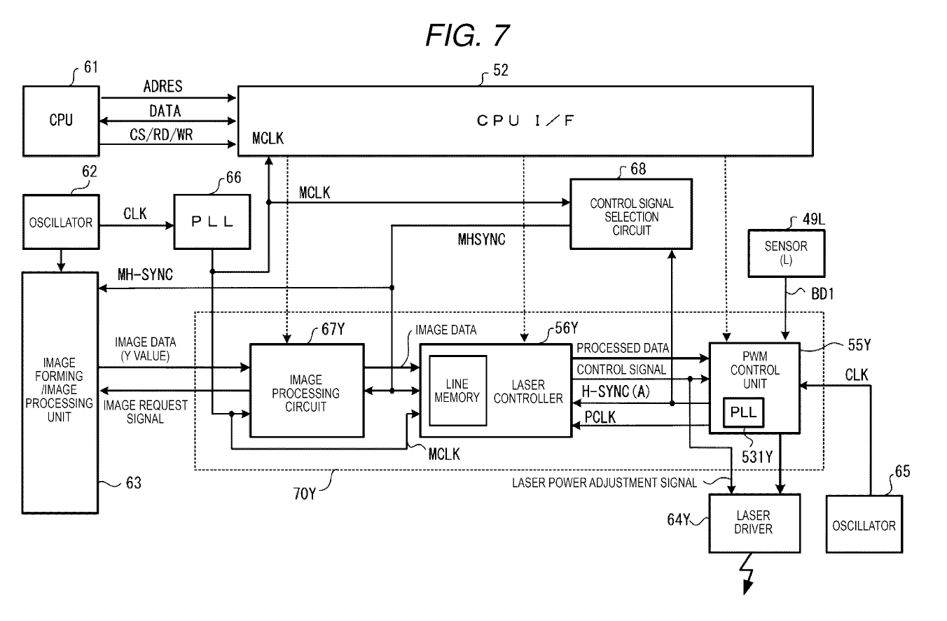

As illustrated in FIG. 6, the image correction device 50 is formed of an integrated circuit such as an application specific integrated circuit (ASIC). An ASIC 60 includes the CPU interface 52, a PLL circuit 66, image processing circuits 67Y, 67M, 67C and 67K, laser controllers 56Y, 56M, 56C and 56K, PWM control units 55Y, 55M, 55C and 55K, and a control signal selection circuit 68. The ASIC 60 is connected to a CPU 61, an oscillator 62, an image forming and image processing unit 63, laser drivers 64Y, 64M, 64C and 64K, an oscillator 65, and the sensors 49L and 49R. Hereinafter, with reference to FIG. 7, a description will be made of a configuration for performing a process related to yellow (Y) in the integrated circuit 60. Processes related to magenta (M), cyan (C), and black (K) are the same as the process related to yellow, and thus configurations for performing the processes will be omitted as appropriate.

The CPU 61 is connected to the CPU interface 52, and controls the CPU interface 52. The CPU 61 supplies an address signal ADRES, various control signals CS, a read signal RD, and a write signal WR to the CPU interface 52. The CPU 61 exchanges data DATA with the CPU interface 52. The CPU interface 52 controls a Y processing circuit 70Y under the control of the CPU 61. The Y processing circuit 70Y includes the image processing circuit 67Y, the laser controller 56Y, and the PWM control unit 55Y.

The oscillator 62 is connected to the image forming and image processing unit 63 and the PLL circuit 66, and outputs the clock CLK to the image forming and image processing unit 63 and the PLL circuit 66. The PLL circuit 66 generates a clock MCLK (image write clock) for the image forming side on the basis of the clock CLK from the oscillator 62. The PLL circuit 66 supplies the generated clock MCLK to the image processing circuit 67Y, the laser controller 56Y, the CPU interface 52, and the control signal selection circuit 68.

The control signal selection circuit 68 receives the scanning synchronization signals H-SYNC from the PWM control units 55Y, 55M, 55C and 55K. Timings of the scanning synchronization signals H-SYNC which are input to the control signal selection circuit 68 are different from each other, and thus the control signal selection circuit 68 selects, for example, the scanning synchronization signal H-SYNC having the earliest timing. The scanning synchronization signal selected by the control signal selection circuit 68 is referred to as MH-SYNC.

The control signal selection circuit 68 supplies the scanning synchronization signal MH-SYNC to the image forming and image processing unit 63, the image processing circuit 67Y, and the laser controller 56Y. The image processing circuit 67Y supplies an image request signal to the image forming and image processing unit 63 according to the image write clock MCLK received from the PLL circuit 66 and the scanning synchronization signal MH-SYNC.

The image forming and image processing unit 63 generates Y, M, C and K image data. In FIG. 7, if the image request signal is received from the image processing circuit 67Y, the image forming and image processing unit 63 supplies Y-value image data of one line to the image processing circuit 67Y. The image processing circuit 67Y performs a predefined image process such as gamma (γ) correction on the image data received from the image forming and image processing unit 63, and supplies the processed image data to the laser controller 56Y.

The laser controller 56Y is formed of the laser control unit 51, the SRAM controller 53, and the SRAM 54 illustrated in FIG. 5. The laser controller 56Y includes a line memory, and temporarily stores the Y-value image data of one line received from the image processing circuit 67Y in the line memory.

The laser controller 56Y stores the set values (the writing position adjustment values and the magnification adjustment values) for performing adjustment of an image writing position in the main scanning direction and image magnification correction (fine adjustment or modulation) for each line. The laser controller 56Y supplies set values corresponding to a reading target line to the PWM control unit 55Y, and causes the PWM control unit 55Y to generate the scanning synchronization signal H-SYNC (A) and the image reading clock PCLK. The laser controller 56Y reads the image data (the Y-value image data of one line) stored temporarily in the line memory according to the scanning synchronization signal H-SYNC (A) and the image reading clock PCLK generated by the PWM control unit 55Y, and supplies the image data to the PWM control unit 55Y. In other words, the image data (the Y-value image data of one line) stored in the line memory of the laser controller 56Y is read from the line memory according to a timing which is adjusted on the basis of the set values corresponding to the line. Consequently, image data in which image distortion is corrected is supplied to the PWM control unit 55Y.

A detection signal BD1 from the optical sensor 49L is supplied to the PWM control unit 55Y. The PWM control unit 55Y adjusts the supplied detection signal BD1 by using the set values for adjusting an image writing position, supplied from the laser controller 56Y, and generates the scanning synchronization signal H-SYNC (A) (a synchronization signal in which a writing position is adjusted). The reference image reading clock CLK is supplied to the PWM control unit 55Y from the oscillator 65.

The PWM control unit 55 includes a PLL circuit 531Y. The PLL circuit 531Y is a frequency converter, and adjusts the clock CLK from the oscillator 65 by using the set values for magnification adjustment (fine adjustment or modulation) supplied from the laser controller 56Y, and generates the image reading clock PCLK (a clock in which magnification is adjusted). The PWM control unit 55Y supplies the generated scanning synchronization signal H-SYNC (H) and image reading clock PCLK to the laser controller 56Y, and receives image data (Y-value image data of one line in which image distortion is substantially corrected) from the laser controller 56Y. The PWM control unit 55Y performs pulse width modulation on the received image data received from so as to generate a binary signal (1 bit PWM signal), and supplies the signal to the laser driver 64Y as a laser driving signal so that a corresponding laser beam is emitted from the light source 43Y. Processes related to magenta (M), cyan (C), and black (K) are performed in the same manner as the process related to yellow, and laser beams corresponding to laser driving signals obtained through the respective processes are emitted from the light sources 43M, 43C and 43K.

As described above, the image correction device according to the embodiment acquires predefined set values (correction information) corresponding to an image forming target line among a plurality of lines forming image data, and performs a process of adjusting a timing for forming an image for the image forming target line on the basis of the acquired set values, and forming the image for the image forming target line according to the adjusted timing. Consequently, distortion is substantially corrected before an image is formed, and thus a correction process to image data such as addition or deletion of pixels to or from image data may not be performed. Therefore, color deviation or step difference, or a stepped image can be reduced, and thus deterioration in image quality can be prevented.

### Second Embodiment

In the above-described embodiment, an example in which laser beams are applied to the polygon mirror 41 from two directions was described. However, this is only an example, and the present embodiment is applicable to a case where a laser beam is applied to the polygon mirror 41 from one direction.

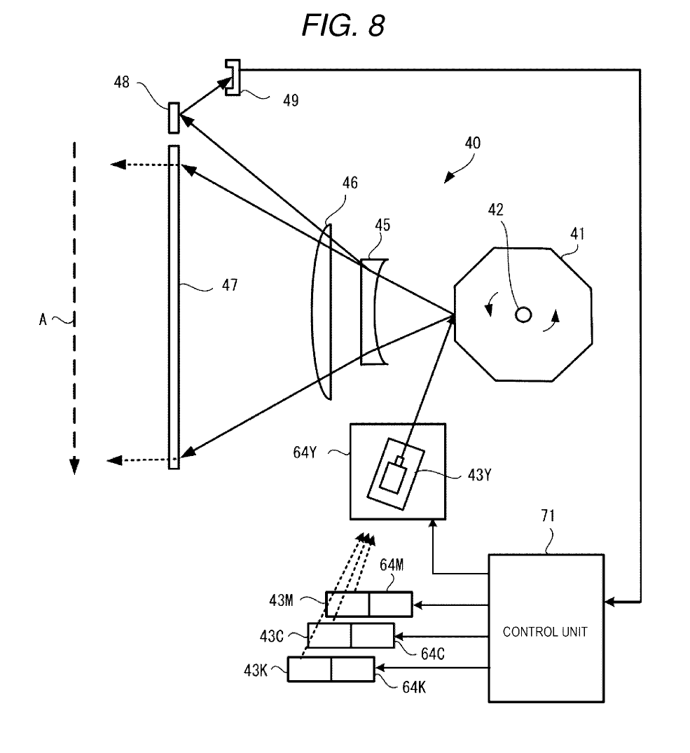

FIG. 8 is a configuration diagram schematically illustrating the laser exposure device 40 of an image forming apparatus according to a second embodiment. In FIG. 8, laser beams from the laser light sources 43Y, 43M, 43C and 43K are applied to the polygon mirror 41 from one direction. The laser light sources 43Y, 43M, 43C and 43K are respectively driven by the laser drivers 64Y, 64M, 64C and 64K. In FIG. 8, for convenience of description, a laser beam from the laser light source 43Y is illustrated to be applied to the polygon mirror 41.

The laser drivers 64Y, 64M, 64C and 64K are controlled by a control unit 71, and respectively change the laser light sources 43Y, 43M, 43C and 43K. Laser beams from the laser light sources 43Y, 43M, 43C and 43K are incident to the polygon mirror 41, and are reflected by the polygon mirror 41. Scanning is performed with laser beams in a direction indicated by a dotted line A in FIG. 8 due to rotation of the polygon mirror 41.

The laser beam reflected by the polygon mirror 41 is converted into parallel light through the first fθ lens 45 and the second fθ lens 46, and then enters the reflection mirror 47 so as to be folded. The reflection mirror 47 actually includes a plurality of mirrors, and the mirrors are disposed to expose the photoconductive drums 22Y, 22M, 22C and 22K to light. The reflection mirror 48 and the optical sensor 49 are provided in an over-scan region (a region which does not contribute to exposure) around a scanning start end of the reflection mirror 47. The optical sensor 49 forms a beam detector, supplies the detection signal BD from the optical sensor 49 to the control unit 71, and generates a scanning synchronization signal (H-SYNC) for synchronization of laser beams in the main scanning direction. The laser light sources 43Y, 43M, 43C and 43K are changed by using the detection signal BD from the optical sensor 49.

In FIG. 8, the detection signal BD from the optical sensor 49 is supplied to the PWM control units 55Y, 55M, 55C and 55K illustrated in FIG. 7. Even if image exposure is performed by using the laser exposure device illustrated in FIG. 8, adjustment or an image writing position, or fine adjustment or modulation (magnification correction) can be performed for each line in one page, and thus image distortion can be substantially corrected before an image is formed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image correction device comprising:
an acquisition unit configured to acquire predefined correction information corresponding to a plurality of lines forming image data;
a store unit configured to store the predefined correction information corresponding to the plurality of lines forming one page image data for each line; and
a control unit configured to adjust a timing for forming an image for the image forming target one line on the basis of the correction information corresponding to the image forming target one line read from the store unit, and form the image for the image forming target one line according to the adjusted timing.

2. The device according to claim 1,
wherein the acquisition unit acquires a writing position adjustment value for adjusting a writing position in an image in a main scanning direction, as the correction information, and
wherein the control unit adjusts the writing position in an image in the main scanning direction on the basis of the writing position adjustment value acquired by the acquisition unit, and forms the image for the image forming target line according to the adjusted writing position.

3. The device according to claim 1,
wherein the acquisition unit further acquires a magnification adjustment value for adjusting the magnification of an image in the main scanning direction, as the correction information, and
wherein the control unit adjusts the magnification of an image in the main scanning direction on the basis of the magnification adjustment value acquired by the acquisition unit, and forms the image for the image forming target line according to the adjusted magnification.

4. (canceled)

5. The device according to claim 1, further comprising:
a polygon mirror configured to expose and scan a photoconductor with a plurality of laser beams; and
a sensor configured to be provided in an over-scan region around a start end of exposure and scanning performed by the polygon mirror and to detect a laser beam reflected by the polygon mirror,
wherein the store unit stores the image for the image forming target at least of one line,
wherein the control unit adjusts a detection signal supplied from the sensor and a reference clock for reading an image, by using the correction information, reads the image for the image forming one target line from the store unit on the basis of the adjusted clock, and writes the image on the basis of the adjusted detection signal.
